(19) United States
(12) Patent Application Publication
(10) Pub. No.: US 2018/0249313 A1
(43) Pub. Date: Aug. 30, 2018

(54) SMART DEVICE, ELECTRONIC APPARATUS, AND NFC-BASED NETWORK CONNECTION METHOD

(71) Applicant: Zhuhai Seine Technology CO., Ltd., Zhuhai (CN)

(72) Inventors: SHAOHUA SHE, Zhuhai (CN); QI HU, Zhuhai (CN); XUAN TAN, Zhuhai (CN)

(21) Appl. No.: 15/958,266

(22) Filed: Apr. 20, 2018

Related U.S. Application Data
(63) Continuation of application No. PCT/CN2016/102328, filed on Oct. 18, 2016.

(30) Foreign Application Priority Data
Oct. 21, 2015 (CN) 201510687731.2

(51) Int. Cl. H04W 4/80; H04W 76/15; H04W 40/24; H04W 76/14

(52) U.S. Cl. CPC H04W 4/80; H04W 76/14; H04W 40/246; H04W 76/15

(57) ABSTRACT

A smart device is provided for establishing a Wi-Fi connection with an electronic apparatus. The smart device includes a first near-field-communication (NFC) module to be coupled to a second NFC module in the electronic apparatus; and a first Wi-Fi module to be coupled to a second Wi-Fi module in the electronic apparatus. The second Wi-Fi module in the electronic apparatus contains a soft access point; after detecting the first NFC module is close to the second NFC module, the first NFC module establishes an NFC connection with the second NFC module, and obtains wireless-network-connection-information of the soft access point through the NFC connection; and using the wireless-network-connection-information of the soft access point, the first Wi-Fi module in the smart device establishes a Wi-Fi connection with the second Wi-Fi module in the electronic apparatus.

### CROSS-REFERENCES TO RELATED APPLICATIONS

This application is a continuation application of PCT Patent Application No. PCT/CN2016/102328, filed on Oct. 18, 2016, which claims the benefit of the Chinese patent application CN201510687731.2, filed on Oct. 21, 2015, titled “Smart Device, Electronic Apparatus, And NFC-Based Network Connection Method”, the entire contents of all of which are hereby incorporated by reference.

### FIELD OF THE TECHNOLOGY

The present invention relates to the field of wireless network connection technology and, more particularly, to a smart device, electronic apparatus, and NFC-based network connection method.

### BACKGROUND OF THE DISCLOSURE

In recent years, with the increase in the degree of intelligence in smart devices, wireless networks have been well-applied and widely used by relying on smart devices. Wireless networks commonly used in smart devices include Wi-Fi (registered trademark) network. The technical solution corresponding to the Wi-Fi is based on the IEEE 802.11 standard to improve the interoperability between wireless network products, which can increase the speed of wireless network information transmission.

As the Wi-Fi technology continues to mature, to achieve direct interconnection among Wi-Fi devices and to help users to complete tasks such as printing, sharing, synchronization, and display in a simpler and more convenient and efficient way, the Wi-Fi Alliance has also established technical standards for Wi-Fi P2P and Wi-Fi Direct.

However, to ensure the security of information transmission between devices, there is an information security verification process before the device is connected to the Wi-Fi network or the devices exchange information through Wi-Fi P2P/Wi-Fi Direct. This verification process usually requires manual setting of checksum and encryption parameters. In the current situation of higher and higher automation requirements for wireless network applications and the increasing popularity of high-level automation applications, manually setting checksum and encryption parameters will inconvenience the user's operation and reduce the While verifying the degree of automation of the process, the efficiency of the verification process is also reduced.

The disclosed methods and systems are directed to solve one or more problems set forth above and other problems.

### SUMMARY

According to one aspect of the present disclosure, a smart device is provided for establishing a Wi-Fi connection with an electronic apparatus. The smart device includes a first near-field-communication (NFC) module to be coupled to a second NFC module in the electronic apparatus; and a first Wi-Fi module to be coupled to a second Wi-Fi module in the electronic apparatus. The second Wi-Fi module in the electronic apparatus contains a soft access point; after detecting the first NFC module is close to the second NFC module, the first NFC module establishes an NFC connection with the second NFC module, and obtains wireless-network-connection-information of the soft access point through the NFC connection; and using the wireless-network-connection-information of the soft access point, the first Wi-Fi module in the smart device establishes a Wi-Fi connection with the second Wi-Fi module in the electronic apparatus.

According to another aspect of the present disclosure, an electronic apparatus is provided for establishing a Wi-Fi connection with a smart device. The smart device includes a first near-field-communication (NFC) module and a first Wi-Fi module. The electronic apparatus includes a second NFC module to be coupled to the first NFC module in the smart device; and a second Wi-Fi module to be coupled to the first Wi-Fi module in the smart device and including a soft access point. After detecting the first NFC module is close to the second NFC module, the second NFC module establishes an NFC connection with the first NFC module, and transmits wireless-network-connection-information of the soft access point to the smart device through the NFC connection; and using the wireless-network-connection-information of the soft access point, the second Wi-Fi module in the electronic apparatus establishes a Wi-Fi connection with the first Wi-Fi module in the smart device.

According to another aspect of the present disclosure, a network connection method based on near-field-communication (NFC) is provided for establishing a Wi-Fi connection between a smart device and an electronic apparatus. The smart device includes a first NFC module and a first Wi-Fi module, the electronic apparatus includes a second NFC module and a second Wi-Fi module, and the first Wi-Fi module in the electronic apparatus has a soft access point. The method includes: when it is detected that the first NFC module in the smart device is close to the second NFC module in the electronic apparatus, establishing, by the first NFC module, an NFC connection with the second NFC module; obtaining, by the first NFC module in the smart device, wireless-network-connection-information of the soft access point through the NFC connection; and using the wireless-network-connection-information of the soft access point, establishing, by the first Wi-Fi module in the smart device, a Wi-Fi connection with the second Wi-Fi module in the electronic apparatus.

Other aspects of the present disclosure can be understood by those skilled in the art in light of the description, the claims, and the drawings of the present disclosure.

### BRIEF DESCRIPTION OF THE DRAWINGS

To further understand the technical solutions of the embodiments of the present invention more clearly, the following briefly introduces the accompanying drawings used for describing the disclosed embodiments and constitute part of the Specification. Apparently, the accompanying drawings in the following description show merely some embodiments of the present invention, and a person of ordinary skill in the technology may derive other drawings from these accompanying drawings without creative efforts.

FIG. 1 illustrates a schematic structural diagram of a near-field communication (NFC) based wireless-network-connection-information exchange system consistent with disclosed embodiments;

FIG. 2 illustrates a schematic flowchart of a method for exchanging wireless-network-connection-information based on NFC consistent with disclosed embodiments;

FIG. 3 illustrates another schematic structural diagram of an NFC-based wireless-network-connection-information exchange system consistent with disclosed embodiments;

FIG. 4 illustrates another schematic flowchart of a method for exchanging wireless-network-connection-information based on NFC consistent with disclosed embodiments;

FIG. 5 illustrates a schematic structural diagram of an image forming apparatus consistent with disclosed embodiments;

FIG. 6 illustrates a schematic structural diagram of a mobile smart device consistent with disclosed embodiments;

FIG. 7 illustrates a schematic flow chart of a process for exchanging wireless-network-connection-information based on NFC and between a mobile smart device and an image forming apparatus consistent with disclosed embodiments;

FIG. 8 illustrates a schematic structural diagram of an NFC-based wireless-network-connection-information exchange system consistent with disclosed embodiments; and

FIG. 9 illustrates another schematic flowchart of a method for exchanging wireless-network-connection-information based on NFC consistent with disclosed embodiments.

### DETAILED DESCRIPTION

The following describes exemplary embodiments in detail, with reference to the accompanying drawings, so as to understand and implement the technical solutions to the technical problems in the present disclosure. Unless otherwise specified, a same number in different drawings may represent a same or similar element. The implementations described in the exemplary embodiments below do not represent all implementations consistent with the present disclosure. On the contrary, the implementations below are merely examples of the apparatus and the methods that are consistent with some aspects of the present disclosure, and should not be used for limiting the present disclosure. Further, as long as there is no conflict, the embodiments of the present invention and features of the embodiments may be combined with each other.

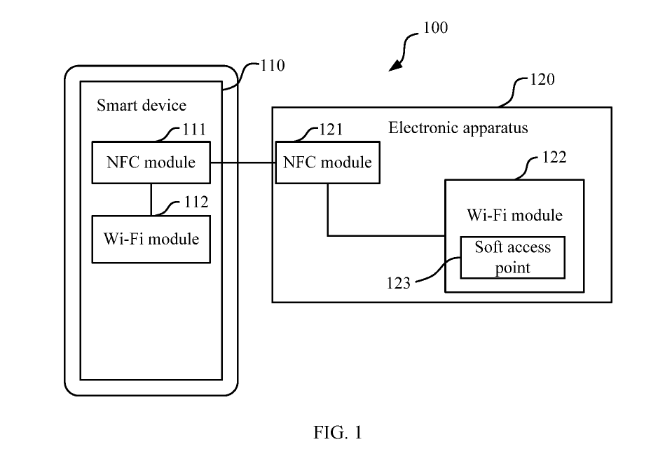

According to the embodiments of the present invention, a system is provided for exchanging wireless-network-connection-information based on short-range communication (hereinafter referred to as a network-connection-system). In certain embodiments, the close-range communication is near-field communication (NFC), also called short-distance wireless communication). As shown in FIG. 1, the network-connection-system 100 mainly includes a smart device 110 and an electronic apparatus 120.

The smart device 110 is provided with an NFC module 111 and a Wi-Fi module 112. The electronic apparatus 120 is provided with an NFC module 121 and a Wi-Fi module 122. The Wi-Fi module 122 in the electronic apparatus 120 is provided with a soft access point (or simply called Soft AP) 123 and may also be provided with a Wi-Fi direct connection (sub)module and/or a WPS (sub)module, as explained in detail below.

In one embodiment, the smart device 110 is a smart phone. In other embodiments, the smart device 110 may also be a tablet computer (such as a Pad) or an e-book reader (such as a Kindle).

When the smart device 110 moves close to the electronic apparatus 120, the NFC module 111 in the smart device 110 may establish a NFC connection with the NFC module 121 in the electronic apparatus 120, so that the smart device 110 can obtain the wireless-network connection information of the Soft AP 123 in the electronic apparatus 120 through the NFC connection. The wireless-network connection information of the Soft AP 123, including the SSID (Service Set Identifier) of the access point, the security mode, the key information, and the like.

After the smart device 110 obtains the wireless-network connection information of the Soft AP 123 from the electronic apparatus 120 by means of NFC, based on the obtained wireless-network connection information, an automatic verification of a Wi-Fi connection between the smart device 110 and the electronic apparatus 120 is performed, and the Wi-Fi connection is established directly after passing the verification.

Thus, according to the disclosed embodiments, by using the NFC to establish the wireless connection between the smart device 110 and the electronic apparatus 120, the following advantages may be achieved: the wireless-network-connection-information is exchanged through NFC, which ensures that the data transmission is more secure; and, through the Wi-Fi connection, the established network-connection-system can complete various tasks, such as information sharing, synchronizing, and displaying, between the smart device 110 and the electronic apparatus 120, ensuring faster task transmission.

In the process of establishing the above network-connection system, the information required for verification during the Wi-Fi connection process is automatically obtained through the NFC technology. Without the user manually setting the verification and encryption parameters, the inputting of the corresponding information is completed, and the verification process between the smart device 110 and the electronic apparatus 120 is automatically completed, which saves the user's operation, improves the degree of automation of the verification process between the smart device 110 and the electronic apparatus 120, and improves the verification efficiency, ensuring the real-timeliness and accuracy of the verification.

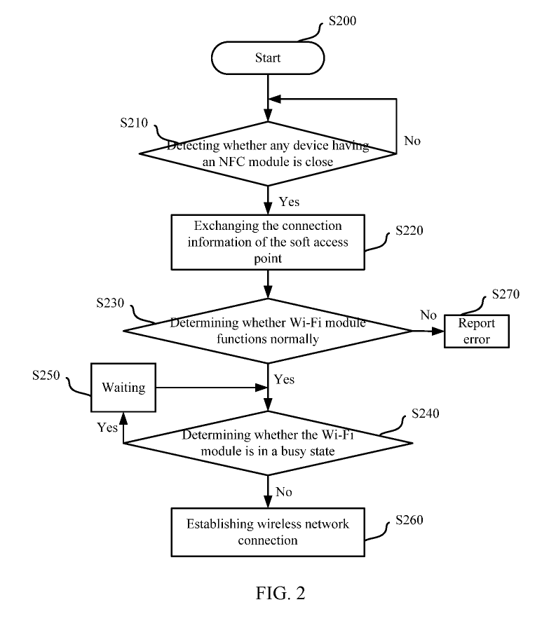

According to the disclosed embodiments, a method for exchanging wireless-network-connection-information based on NFC is also provided. With reference to the smart device 110 and the electronic apparatus 120 shown in FIG. 1, as shown in FIG. 2, the method mainly includes the following steps.

Step S200: the exchanging process starts.

Step S210: the electronic apparatus 120 detects whether the smart device having an NFC module in a valid operating state is close to the electronic apparatus 120.

In one embodiment, the smart device with the NFC module in the valid operating state is detected by the NFC module 121 in the electronic apparatus 120. If it is detected that the smart device is close to the electronic apparatus 120, Step S220 is performed; otherwise, if it is detected that the smart device is not close to the electronic apparatus 120, or the NFC module in the smart device is not in a valid operating state, the exchanging process continues from Step S210. In this process, if the smart device does not have an integrated NFC module, it will not be detected by the electronic apparatus 120. On the other hand, if the smart device is integrated with an NFC module, but the NFC module is not turned on when it is close to the electronic apparatus 120, or the NFC module is turned on but it is not in a valid operating state (such as being in an NFC fault state, etc.), the smart device 110 with an operational NFC module still cannot be detected by the electronic apparatus 120.

Step S220, the electronic apparatus 120 establishes an NFC connection with the smart device and sends the locally-stored wireless-network-connection-information of the soft access point to the smart device.

The smart device with the NFC function obtains the wireless-network-connection-information of the soft access point stored in the electronic apparatus 120 through the NFC. The wireless-network-connection-information includes the SSID (Service Set Identifier ID) of the soft access point, security mode, and encryption key information, etc.

Step S230, the electronic apparatus 120 determines whether its own Wi-Fi module is available. If it is determined that its own Wi-Fi module is available, the process proceeds to Step S240; otherwise the process proceeds to Step S270.

For example, the electronic apparatus 120 may perform self-inspection on its own Wi-Fi module. If the Wi-Fi module is functioning normally, the “normal” message is fed back to the smart device through the NFC, and Step S240 is executed; otherwise, if the Wi-Fi module is not functioning normally, Step S270 is executed.

It should be noted that, in FIG. 2, Step S230 is performed after Step S210. In other embodiments, Step S230 may also be performed before Step S210. Actually, there is no strict order between Step S230 and Step S210. Step S230 and Step S210 may also be synchronously performed, which is also feasible.

Step S240, the electronic apparatus 120 determines whether its own Wi-Fi module is in a busy state. If yes, then the process proceeds to Step S250; otherwise, the process proceeds to Step S260.

Specifically, the electronic apparatus 120 may determine, according to the wireless-network-connection-information obtained in Step S220, whether its own Wi-Fi module is in a busy state. The busy state of the Wi-Fi module of the electronic apparatus 120 mainly may include the following situations:

1) Devices other than the smart device 110 are connecting with the soft access point of the Wi-Fi module in the electronic apparatus 120;

2) The Wi-Fi module of the electronic apparatus 120 is in a restart state;

3) The Wi-Fi module of the electronic apparatus 120 is in a state of being configured (e.g., changing an SSID or a password, etc.); and

4) The Wi-Fi module of the electronic apparatus 120 is handling other processes (e.g., basic network mode connection, WPS connection, or direct-connection-mode connection, etc.).

It should be noted that, in other embodiments, the method for exchanging wireless-network-connection-information based on NFC may also be configured to: if it is determined that the soft access point in the Wi-Fi module of the electronic apparatus 120 is busy, the process may return to Step S220, and the wireless-network-connection-information of the soft access point may be obtained again, and then continue to Step S230, Step S240, and the like.

Step S250, after waiting a predetermined period of time, Step S240 is performed again.

Step S260, a wireless network connection is established between the smart device and the electronic apparatus 120.

Step S270, an error is reported, which indicates that the Wi-Fi module in the electronic apparatus 120 is abnormal, the network connection process is terminated, and an error message is displayed.

To make those skilled in the art easily understand the technical solutions in the disclosed embodiments, certain aspects of the NFC and Wi-Fi are explained below.

The NFC technology is evolved from RFID (short for Radio Frequency Identification) and is backward compatible with RFID. The NFC technology uses bi-directional identification and connection to allow non-contact point-to-point data transmission between electronic apparatus (devices). Currently, reliable communication distance is about 10 centimeters (cm), and wireless networks can be established quickly and automatically, so as to provide the cellular devices, the Bluetooth devices, and the Wi-Fi devices with a communication connection. Thus, the electronic apparatus can communicate within a short distance, which greatly simplifies the entire process of authentication and identification, and enables the electronic apparatus to access each other more directly and safely. The NFC standard organization has now established a flexible gateway system to detect and select one of three operating modes: NFC card emulation mode, reader mode, and point-to-point communication mode. To reduce the cost of the electronic apparatus 120, in one embodiment, the NFC module 121 in the electronic apparatus may be an NFC tag, and the smart device may be an NFC chip with read/write functions. When the smart device is close to the electronic apparatus, the NFC chip supplies power to the NFC tag to ensure communication between the two.

Correspondingly, the NFC tag receives power from the NFC chip.

Accordingly, in one embodiment, the NFC module in the smart device is an NFC chip, the NFC module in the electronic apparatus is an NFC tag. When it is detected that the NFC chip and the NFC tag card are close to each other, the NFC chip supplies power to the NFC tag.

In certain embodiments, it may also be configured such that the NFC module in the smart device is an NFC reader/writer, and the NFC module in the electronic apparatus is an NFC tag.

Therefore, only a relatively inexpensive NFC tag may need to be provided in the electronic apparatus to allow the smart device to be used for quickly establish the NFC connection with the electronic apparatus.

Wi-Fi technology includes multiple network modes, such as the Ad-hoc mode.

This type of network mode is not widely used in practical applications due to its weak security and low transmission speed. There is also an access-point-based basic network mode. This network mode is widely used due to its technological maturity. The access point here is usually a wireless access point. A wireless access point is an access point that uses wireless devices (mobile devices such as mobile devices and laptops and other wireless devices) to enter a wired network. It is mainly used in broadband homes, buildings, campus interiors, campus interiors, warehouses, factories, etc., where monitoring is performed, the typical distance covers tens of meters to hundreds of meters, and it can also be used for long-distance transmission. At present, the farthest distance can reach about 30 kilometers (Km). The main technology is the IEEE802.11 series. The Wi-Fi direct connection technology can directly establish the information exchange between two devices without an external access point. The Wi-Fi direct connection is implemented by: firstly forming a group owner and a client(s) by searching and negotiating among at least two devices, and then completing the information exchange and sharing between the two devices by exchanging Mac address information. The WPS (Wi-Fi Protected Setup) is a certification project implemented by the Wi-Fi Alliance. It focuses on simplifying the installation and security configuration of wireless LANs. Wi-Fi Protected Setup helps users automatically set the network name (SSID), configure powerful data encoding and authentication functions. Users can enter the WLAN safely just by entering their personal information code or pressing a button, greatly simplifying the operation of wireless security configuration.

The soft access point is based on the hardware part that is a standard wireless network card, but it provides the same signal transfer and routing functions as the hard access point through the driver program. The cost of the soft access point is very low. Compared with a common wireless network card, the integrated driver/software of the soft access point can provide a great ease of installation of the soft access point to users interacting with the network for the first time. In one embodiment, the Wi-Fi connection scheme is to exchange the SSID information and the encryption key information of the soft AP directly during the NFC process, so that it is possible to quickly establish the wireless connection between the two devices.

Thus, according to disclosed embodiments, by exchanging information of the soft access point to establish a wireless network connection between two devices, comparing with other Wi-Fi modes, at least one of the following advantages may be achieved.

1. Through the soft AP module provided on the electronic apparatus, communication between the smart device and the electronic apparatus can also be realized when the electronic apparatus is not connected to an external AP; and

2. By exchanging of the wireless-network-connection-information of the soft AP on the electronic apparatus through the NFC, the smart device and the electronic apparatus do not need a complicated device search process in the process of connecting to the wireless network, which improves the connection speed and efficiency.

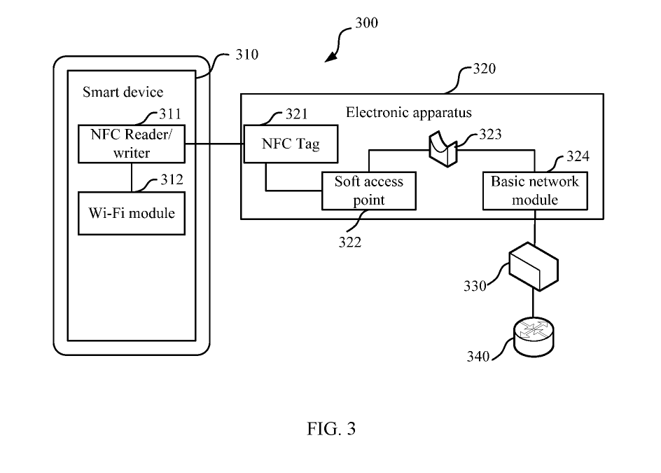

Further, certain addition, variation, and/or optimization may also be applied to the above described wireless-network-connection-information exchanging system/device based on the near field communication (NFC). As shown in FIG. 3, the NFC-based system (network connection system) 300 for exchanging wireless-network-connection-information includes a smart device 310 and an electronic apparatus 320. The smart device 310 includes an NFC reader/writer 211 and a Wi-Fi module 312, and the electronic apparatus 320 includes an NFC tag 321 and a soft access point (Soft AP) 322.

In the network connection system 300, the electronic apparatus 320 also includes a basic network module 324. A network bridge 323 is provided to establish communication between the basic network module 324 and the Soft AP 322. Further, the basic network module 324 is able to connect with an external network (Internet) through an external access point (AP) 330 and a router 340, which enables the Soft AP 322 to connect with external network via the network bridge 323 and the basic network module 324. Certainly, the external AP 330 may also be a wireless AP with a routing function.

Thus, in one embodiment, the smart device 310 is able to access external networks directly via the Soft AP 322 connected to the electronic apparatus 320. That is, when the smart device 310 is connected to an external network (e.g. Wi-Fi), without a complicated authentication process, the NFC reader/writer 311 in the smart device 310 may acquire the information about the Soft AP and/or wireless-network-connection-information in the basic network mode to establish a wireless network connection between the smart device 310 and the electronic apparatus 320. The information about the Soft AP and/or wireless network connection stored in NFC tag 321, including information about Service Set Identifier (SSID), security mode, busy status, and encryption keys.

For example, the Soft AP 322 may provide a default IP address for communication with other devices to be connected. In terms of this default IP address, users can modify it by using the interface provided by the Soft AP. Soft AP 322 is also provided with a dynamic host configuration protocol (DHCP), which can automatically assign IP addresses to Wi-Fi devices connected to Soft AP 322, and those IP addresses assigned are in the same network segment as the IP address of the Soft AP in the electronic apparatus, so as to establish communication between Soft AP and Wi-Fi devices connected conveniently.

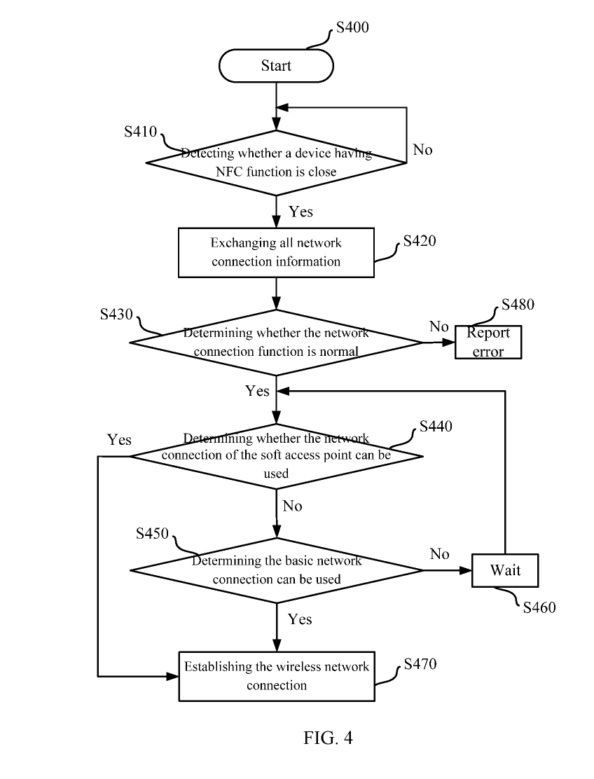

In one embodiment, an NFC-based wireless-network-connection-information exchanging method is also provided, correlating with the smart device 310 and the electronic apparatus 320 in FIG. 3, as shown in FIG. 4, the exchanging method may include the following steps.

Step S400, the method starts.

Step S410, the electronic apparatus 320 detects whether there is an NFC-functioned device close to the electronic apparatus.

The electronic apparatus 320 may determine whether there is an NFC-functioned device approaching by detecting whether the NFC tag of the electronic apparatus 320 itself is read or written. If yes, then Step S420 is executed; otherwise, return to Step S410 to resume detection.

Step S420, establishing an NFC connection between the electronic apparatus 320 and an approaching smart device, and then exchanging all wireless-network-connection-information.

The smart device with an NFC reader/writer may, based on the NFC, obtain the wireless network connection information of the Soft AP and the basic network stored in NFC tag, such as SSID, security mode, busy status, encryption key information, and so on.

Step S430, the electronic apparatus 320 determines whether the Wi-Fi module of itself is available. The electronic apparatus may conduct self-test on its Wi-Fi module, and if the Wi-Fi module functions normally, sends “normal” message to the smart device through the NFC connection, and Step S440 is performed; otherwise, Step S480 is executed.

It should be noted that, in above embodiments, Step S430 is executed after Step S410. While in other embodiments, Step S430 may be performed before Step S410. There is no strict order to execute Step S430 and Step S410, and it is also feasible to perform Step S430 and Step S410 at the same time.

Step S440, the electronic apparatus 320 determines whether its own Soft AP is in a busy state. Based on the wireless-network-connection-information obtained in Step S420, the electronic apparatus 320 determines whether the Soft AP is in a busy state. If yes, Step S450 is performed; otherwise, Step S470 is performed.

The busy state may include: devices other than the smart device 310 are connecting with the soft access point of the Wi-Fi module in the electronic apparatus 320; the Wi-Fi module of the electronic apparatus 320 is in a restart state; the Wi-Fi module of the electronic apparatus 320 is in a state of being configured (e.g., changing an SSID or a password, etc.); the Wi-Fi module of the electronic apparatus 320 is handling other processes; and/or the number of users (number of smart devices) connected to the Soft AP exceeds the maximum number of access that Soft AP can accept.

It should be noted that, if it is determined that the soft access point in the Wi-Fi module of the electronic apparatus 120 is in the busy state, the method may return to Step S420, and the wireless-network-connection-information of the soft access point may be obtained again, and then continue to Step S430, Step S440, and the like.

Step S450, it is determined whether the basic network connection is available. Based on the wireless-network-connection-information obtained in step S420, the basic network connection is determined whether it is in a busy state. If yes, Step 460 is executed; otherwise, Step S470 is performed.

It should be noted that if the basic network connection is determined in the busy state, Step S420 may be revisited, re-obtaining the network connection information, and then Step 430 and Step S440 and so on may be performed again.

Step S460, after a predetermined period of time, based on the wireless-network-connection-information obtained in Step S420, the smart devices perform Step S440 again and then try network connection with the Soft AP in the electronic apparatus.

Step S470, establishing a wireless network connection between the smart device and the electronic apparatus.

Step S480, an error is reported, indicating the Wi-Fi module in the electronic apparatus is abnormal.

Thus, according to disclosed embodiments, the Soft AP module and the basic network module in the electronic apparatus can coexist. When one of the network modules is in the busy state, users can choose the other network module to connect to the wireless network. Therefore, compared with the access that can only be performed on one type of network, the disclosed embodiments are more user-friendly, and provide more choices of network access, improving the flexibility of network access.

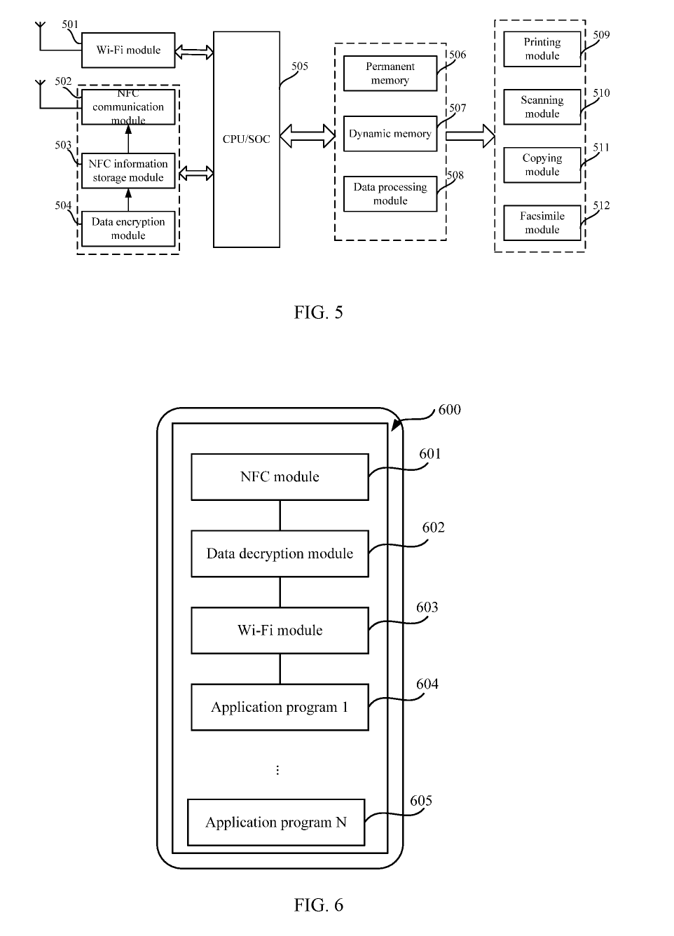

As shown in FIG. 5, in certain embodiments, an image forming apparatus 500 is provided. The image forming apparatus 500 includes a Wi-Fi module 501 and an NFC communication module 502, and also includes an NFC information storage module 503, a data encryption module 504, a central control unit (e.g., a CPU or SOC (system-on-chip)) 505, a data storage module, a data processing module 508, a printing module 509, a scanning module 510, a copying module 511, and a facsimile module 512. The NFC information storage module 503 includes memory storing wireless-network connection information, and the data storage module comprises a permanent memory 506 and a dynamic memory 507.

The image forming apparatus 500 may also include a previously-described basic network module, and a network bridge establishing communication between the basic network module and the soft access point. The basic network module and the network bridge are not shown in FIG. 5, and may be referred to descriptions in above sections.

As shown in FIG. 6, the smart device 600 includes a Wi-Fi module 603 and an NFC module 601. A data decryption module 602 is further provided and a plurality of application programs are installed. In FIG. 6, an application program 1 is shown as 604, and application programs N is shown as 605. These application programs may acquire state information of all modules of the image forming apparatus 500 through a Wi-Fi network and/or an NFC network, and may also control the image forming operation of the image forming apparatus 500 through network protocols, such as sending a print job to the image forming apparatus 500, controlling the on/off switch of the image forming apparatus 500, and/or acquiring the consumables status information and the like in the image forming apparatus 500.

It should be noted that, in one embodiment, the NFC module 601 and the data decryption module 602 can be directly configured in a print-job-related application.

As described above, because the data encryption module 504 is provided in the image forming apparatus 500, and the smart device 600 is provided with a data decryption module 602, the data encryption module 504 in the image forming apparatus 500 encrypts the wireless-network-connection-information and then sends it to the decryption module 602 of the smart device 600. The information is then decrypted by the data decryption module 602 of the smart device 600, and the decrypted information is then used for the network connection between the smart device 600 and the image forming apparatus 500. Therefore, the data encryption module 504 and the data decryption module 602 can ensure the security of the network connection. This can also prevent an irrelevant smart device from erroneously reading the information stored in the NFC information storage module 503 in the image forming apparatus.

The NFC information storage module 503 and the data encryption module 504 may be integrated with the NFC communication module 502; or the NFC information storage module in the image forming apparatus 500 may also be used to store the wireless-network-connection-information, and the data processing module 508 may be used to process the encryption operation of the wireless-network-connection-information.

The following explains in detail the wireless-network-connection-information with reference to Table 1. The wireless-network-connection-information includes at least one of the data in Table 1.

TABLE 1
The definition of data in the NFC information storage module

| Data items | Description | Length (Byte) |
|---|---|---|
| Network mode | | |
| 0x01 - basic network mode | Wireless network establishing mode | 2 |
| 0x02 - Soft AP mode | between the image forming apparatus | |
| 0x03 - Wi-Fi direct mode | and the mobile device | |
| SSID | The SSID of the image forming apparatus | 64 |
| | being a Soft AP or Wi-Fi Direct GO | |
| Security mode | | |
| 0x01 - Open mode | The security mode provided external | 2 |
| 0x02 - WEP mode | devices when the image forming apparatus | |
| 0x03 - WPA mode | acts as a Soft AP or Wi-Fi Direct GO | |
| 0x04-WPA2 personal mode | | |
| 0x05-WPA2 enterprise mode | | |
| Key | The authentication key required to access | 128 |
| | the Wi-Fi network of the image forming | |
| | apparatus | |
| BSSID (MAC address) | The wireless MAC address of the image | 6 |
| | forming apparatus provided when the | |
| | image forming apparatus acts as a | |
| | Soft AP or Wi-Fi Direct GO | |
| Name of image forming | The name of the image forming apparatus | 32 |
| apparatus | | |
| Control command | The control command sent by the mobile | 4 |
| 0x01~0xFFFFFFF | device to the image forming apparatus | |
| State of image forming | The Wi-Fi network state of the image | 2 |
| apparatus | forming apparatus (including the basic | |
| | network or the Soft AP or the Wi-Fi Direct) | |
| State of mobile device | The Wi-Fi network state of the mobile | 2 |
| | device | |
| Encryption information | The encrypted information of the encrypted | 32 |
| | data of the image forming apparatus | |

As a Wi-Fi P2P method, Wi-Fi Direct provides two working modes: Group Owner (GO) mode and Client mode. Which mode devices operate in is determined by mutual negotiation when the two devices start to connect. After a successful connection, GO is responsible for managing the entire network and providing an access point function, similar to the function of Soft AP. In one embodiment, if the electronic apparatus does not support the Soft AP mode or the Soft AP mode has an error, and if the electronic apparatus supports the Wi-Fi Direct function, the Wi-Fi Direct may be fixed (or forced) to work in the GO mode. Thus, the electronic apparatus may provide similar Soft AP functions and SSID to facilitate the access of other devices.

It should be noted that, the foregoing wireless-network-connection-information may be default information set when the image forming apparatus is manufactured, or may be written by the user into the NFC information storage module 503 during use of the image forming apparatus. The Wi-Fi connection can be connected through the Wi-Fi Direct mode or the WPS mode in addition to the above connection through the Soft AP mode.

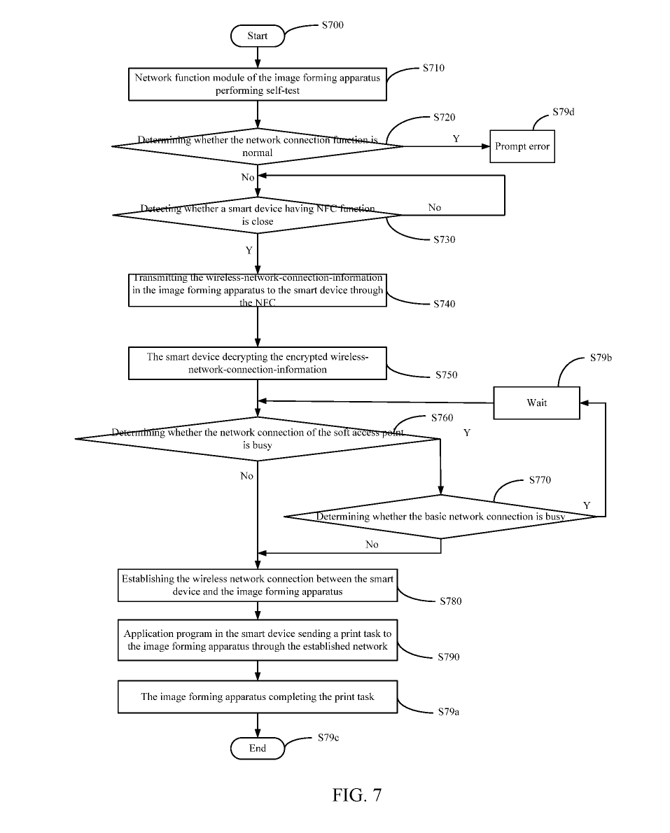

Further, a method is also provided for establishing a wireless network between a smart device and an image forming apparatus based on NFC, with reference to the image forming apparatus 500 shown in FIG. 5 and the smart device 600 shown in FIG. 6, as shown in FIG. 7, the method may include the following steps.

Step S700, the method starts.

Step S710, the network function module in the image forming apparatus 500 performs self-test. Specifically, the Wi-Fi module and/or the NFC communication module in the image forming apparatus are started to perform a self-test.

Step S720, the image forming apparatus 500 determines whether there is an abnormality in the network function. For example, the image forming apparatus 500 determines whether or not its own network function is abnormal based on the self-test result. If the network function is abnormal, Step S79d is performed; otherwise, step S730 is performed.

Step S730, the image forming apparatus 500 determines whether there is a smart device with an NFC function approaching. The NFC communication module in the image forming apparatus detects whether there is a proximity of the smart device with the NFC function. If there is, the NFC is established between the image forming apparatus 500 and the near NFC-enabled device, and Step S740 is performed; otherwise, Step 730 may be repeated. In other embodiments, Step S710 may also be re-executed when there is no smart device close to the image forming apparatus 500.

Step S740, the wireless-network-connection-information in the image forming apparatus 500 is transmitted to the smart device 600 through the NFC. The smart device 600 acquires wireless-network-connection-information stored in the NFC information storage module of the image forming apparatus 500. The received information may be encrypted.

Step S750, the smart device 600 decrypts the encrypted wireless-network-connection-information. The smart device 600 decrypts the wireless-network-connection-information received in Step S740 according to a preset decryption program according to the application program in the smart device, and obtains the decrypted wireless-network-connection-information.

Step S760, it is determined whether the soft access point network in the image forming apparatus 500 is busy. According to the wireless-network-connection-information acquired in Step S740, it is determined whether the soft access point is in a busy state. If the soft access point is not in the busy state, Step S780 is performed; otherwise, Step S770 is performed.

It should be noted that, if it is determined that the soft access point in the Wi-Fi module of the image forming apparatus 500 is busy, the process may return to step S740 to re-acquire the network connection information, and then perform Step S750 and Step S760 again. Of course, Step S779b may also be performed, and then Step S760 may be performed.

Step S770, it is determined whether the basic network in the image forming apparatus 500 is busy. According to the wireless-network-connection-information acquired in Step S740, it is determined whether the basic network connection is in a busy state. If yes, Step S79b is performed; otherwise Step S780 is performed.

It should be noted that, if it is determined that the basic network is busy, it may go back to step S740 or step S710 to continue execution.

Step S780, a network connection between the smart device 600 and the image forming apparatus 500 is established.

Step S790, according to the application program in the smart device 600, and through the network established in Step S780, a print task can be sent to the image forming apparatus 500.

Step S79a, after receiving the task sent by the smart device 600, the image forming apparatus 500 completes the corresponding print job. Of course, in Step S790, the smart device 600 may also send tasks other than printing to the image forming apparatus 500, and the image forming apparatus 500 receives the tasks and then executes the corresponding process.

Step S79b, after waiting for a predetermined period of time, the smart device 600 executes Step S760 again based on the wireless-network-connection-information acquired in Step S740, and then attempts to perform a network connection with the soft access point in the image forming apparatus 500.

Step S79c, the method ends.

Step S79d, an error is indicated, such as prompting that the Wi-Fi module and/or the NFC function in the image forming apparatus 500 is abnormal.

In addition, as described in Table 1, the Wi-Fi Direct information may also be included in the wireless-network-connection-information, so a Wi-Fi Direct module may be added in the image forming apparatus 500 and in smart device 600. The respective Wi-Fi Direct modules in the image forming apparatus 500 and the device 600 support establishment of a Wi-Fi Direct connection between the image forming apparatus 500 and the smart device 600. Correspondingly, a step of determining whether the Wi-Fi Direct module in the image forming apparatus is in a busy state may be added between Step S770 and Step S780, so that when the smart device 600 is connected to the image forming apparatus 500, there is another type of network connection can be selected. Moreover, there is no strict restriction on the order of selecting the soft access point connection, the basic network connection, and the Wi-Fi Direct connection, and the order can be set based on actual needs or may be set randomly.

Thus, with the technical solutions in the disclosed embodiments, even the conventional image forming apparatus can be made more intelligent. By establishing NFC communication between the smart device and the image forming apparatus, the wireless-network-connection-information is exchanged, and then the smart device sends the print job and other tasks to the image forming device through the wireless network, ensuring that the user can complete print job and other tasks more conveniently and safely. Comparing performing tasks such as a print job with respect to a conventional PC-connected image forming apparatus, the disclosed image forming apparatus greatly improves the convenience of the user, enriches the options of the user, and also expands the application scene of the image forming apparatus.

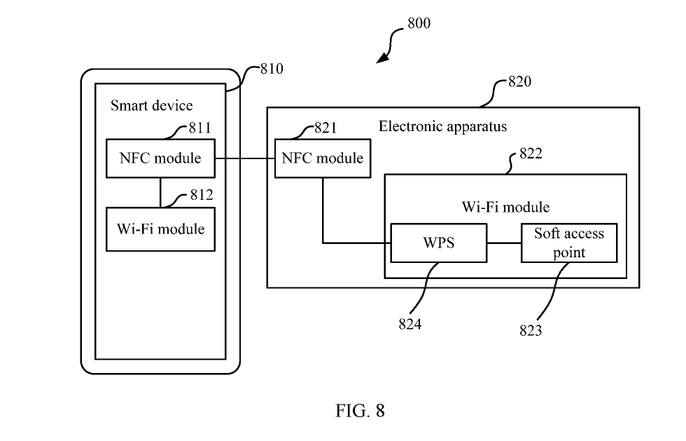

As shown in FIG. 8, in certain embodiments, the Wi-Fi module 822 of the electronic apparatus 820 is provided with a WPS sub-module 824 supporting a Wi-Fi Protected Setup (Wi-Fi Protected Setup) wireless network connection mode, where devices that have passed WPS can now provide users with two installation solutions:

1) Input pin code—mandatory configuration for WPS certified devices;

2) Button Configuration (pbc)—This can be either a hardware button on the device or a software simulated button (optional for wireless clients).

Correspondingly, the smart device 810 also supports the WPS wireless network connection mode and also has a WPS sub-module. A wireless connection can be established between the smart device 810 and the electronic apparatus 820 through the WPS protocol.

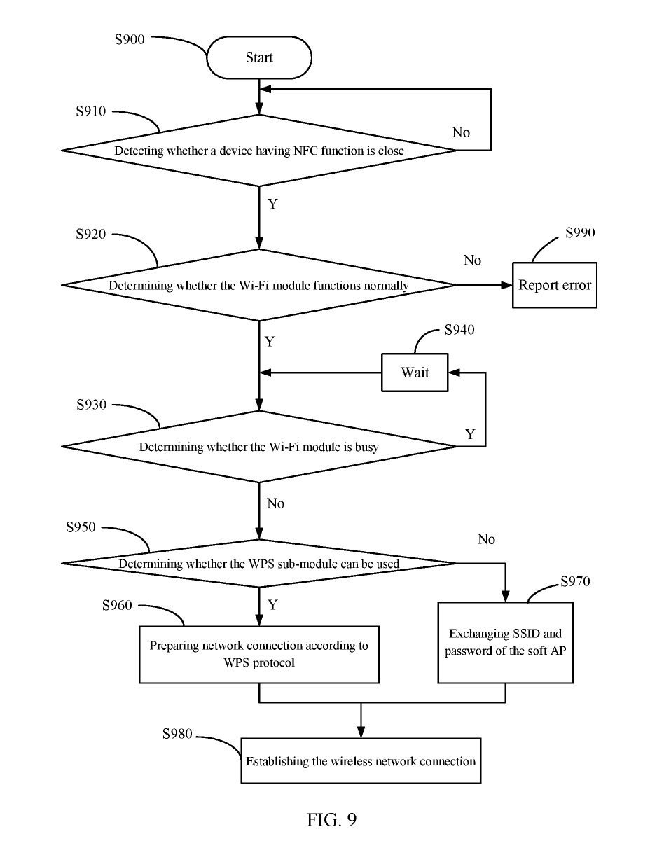

FIG. 9 shows a method for exchanging wireless-network-connection-information based on NFC provided by the disclosed embodiments. With the scenario shown in FIG. 8 and the flow shown in FIG. 2, the method mainly includes the following steps.

Step S900, the method starts.

Step S910, the electronic apparatus 820 detects whether the smart device 810 having the NFC module in a valid operating state is close.

In one embodiment, the smart device 810 with the NFC module in the valid operating state is detected by the NFC module in the electronic apparatus 820; if yes, then Step S920 is executed; otherwise, the process continues from Step S910 to detect the smart device again.

Step S920, the electronic apparatus 820 determines whether its own Wi-Fi module is normal (available). If it is normal, the electronic apparatus 820 executes Step S930; otherwise, it proceeds to step S990.

Step S930, the electronic apparatus 820 determines whether its own Wi-Fi module is in a busy state. If yes, then the method proceeds to step S940. Otherwise, step S950 is performed.

Step S940, after waiting for a predetermined period of time, step S930 is performed again.

Step S950, it is determined whether the smart device supports the WPS wireless network connection mode and whether the WPS sub-modules in the electronic apparatus 820 and the smart device 810 are in a normal state. When the smart device supports the WPS wireless network connection mode and the WPS sub-modules in the electronic apparatus 820, and the smart device 810 are in a normal state, the process goes to Step S960, otherwise goes to Step S970.

Step S960, a network connection is established between the smart device 810 and the electronic apparatus 820 according to the WPS protocol. Through the NFC module 811 in the smart device 810 and the NFC module 821 in the electronic apparatus 820, the respective Wi-Fi modules in the smart device 810 and the electronic apparatus 820 are triggered to prepare to establish a wireless network connection according to the WPS protocol.

Specifically, according to the specific hardware configuration in the smart device 810 and the electronic apparatus 820, a pin code or a pbc connection method is performed. In this way, the technical solution in the first embodiment does not need to exchange SSID and password information, even if the user updates the SSID and password information of the soft access point in the Wi-Fi module, and has not yet been updated to the NFC module 821 in the electronic apparatus 820, still the wireless network connection between the smart device 810 and the electronic apparatus 820 may be established.

For the pin code connection scheme, this may be accomplished by directly exchanging the pin code required for the WPS setup connection process between the NFC module 811 in the smart device 810 and the NFC module 821 in the electronic apparatus 820. Therefore, compared to the conventional WPS connection methods, the cumbersome operation by the user to input the pin code can be saved. For the connection scheme of the pbc connection (button configuration), the button configuration information may be directly obtained through the NFC module 811 in the smart device 810 and the NFC module 821 in the electronic apparatus 820, i.e., equivalent to the trigger signal corresponding to pressing the button on the PCB panel by the user.

Step S970, the SSID and password information stored in the soft access point are exchanged. In this way, for the smart device 810 and the electronic apparatus 820 that cannot support the WPS wireless network connection mode, it can automatically switch to establishing a wireless network connection between the two through the SSID and the password information.

It should be noted that step S970 is not a necessary step in the wireless network connection method. In this regard, when it is determined, in Step S950, that the WPS sub-module is not available, Step S990 may be directly performed to prompt an error message.

Step S990, an error is reported, and an error message such as an error in the Wi-Fi module in the electronic apparatus 820 is prompted, the network connection process is terminated, and an error message is displayed.

The technical features of Step S950 and Step S960 may also be combined with the previously described technical solutions to further optimize the connection method of the wireless network. In addition, Step S950 may also be set to first determine whether there is soft access point connection information and, when the soft access point connection information is available, perform the same Wi-Fi connection determination process as previously described. When soft access point connection mode is not available, the disclosed WPS mode may then be performed, so as to establish a wireless network connection between the smart device and electronic apparatus.

Accordingly, the disclosed technical solution utilizes the soft AP connection and, compared to connection methods based on basic network connection, can effectively avoid a complicated search process in the connection process and improve the connection efficiency and accuracy. Compared to connection methods using an external AP (external router), the disclosed technical solution fixes a soft AP inside the electronic apparatus, which can effectively avoid instability factors and improve connection stability.

Those skilled in the art should understand that the above components of the apparatus and/or devices provided by the disclosed embodiments and the steps in the disclosed methods may be integrated in a single computing device or distributed over a network formed by multiple computing devices. Alternatively, they can be implemented with computer-executable program code. Thus, they may be stored in a storage device and executed by a computing device, or they may be separately fabricated into individual integrated circuit modules, or multiple modules or steps may be implemented as a single integrated circuit module. Thus, the present invention is not limited to any specific combination of hardware and software.

It should be noted that the above description is only some embodiments of the present invention, and is not intended to limit the present invention in any form. A person skilled in the art can make other possible variations of or simple replacements for the technical solution without departing from the invention and the technical contents, which are all within the protection scope of the technical solution of the invention.

What is claimed is:

1. A smart device for establishing a Wi-Fi connection with an electronic apparatus, comprising:
a first near-field-communication (NFC) module to be coupled to a second NFC module in the electronic apparatus; and
a first Wi-Fi module to be coupled to a second Wi-Fi module in the electronic apparatus,
wherein:
the second Wi-Fi module in the electronic apparatus contains a soft access point;
after detecting the first NFC module is close to the second NFC module, the first NFC module establishes an NFC connection with the second NFC module, and obtains wireless-network-connection-information of the soft access point through the NFC connection; and
using the wireless-network-connection-information of the soft access point, the first Wi-Fi module in the smart device establishes a Wi-Fi connection with the second Wi-Fi module in the electronic apparatus.

2. The smart device according to claim 1, further comprising:
a data decryption module corresponding to a data encryption module in the electronic apparatus, wherein:
when the first NFC module in the smart device obtains the wireless-network-connection-information of the soft access point through the NFC connection, the data encryption module encrypts the wireless-network-connection-information, and the encrypted wireless-network-connection-information is provided to the data decryption module; and
the data decryption module decrypts the encrypted wireless-network-connection-information, and provided the decrypted wireless-network-connection-information to the first NFC module in the smart device.

3. The smart device according to claim 1, wherein:
the first Wi-Fi module in the smart device includes a first Wi-Fi direct module;
the second Wi-Fi module in the electronic apparatus includes a second Wi-Fi direct module; and
when the first NFC module in the smart device does not obtain the wireless-network-connection-information of the soft access point through the NFC connection, the first Wi-Fi direct module in the smart device establishes a Wi-Fi Direct connection with the second Wi-Fi direct module in the electronic apparatus.

4. The smart device according to claim 1, wherein:
the smart device includes a first WPS sub-module;
the electronic apparatus includes a second WPS sub-module; and
when the first NFC module in the smart device does not obtain the wireless-network-connection-information of the soft access point through the NFC connection, the first Wi-Fi module in the smart device establishes a wireless network connection with the second Wi-Fi module in the electronic apparatus based on WPS protocols.

5. The smart device according to claim 4, wherein:
when the first NFC module is close to the second NFC module, the first NFC module in the smart device obtains a pin code or button configuration information through the NFC connection; and
the first WPS sub-module in the smart device establishes the wireless network connection with the second WPS sub-module in the electronic apparatus using the pin code or the button configuration information.

6. An electronic apparatus for establishing a Wi-Fi connection with a smart device, wherein the smart device includes a first near-field-communication (NFC) module and a first Wi-Fi module, the electronic apparatus comprising:
a second NFC module to be coupled to the first NFC module in the smart device; and
a second Wi-Fi module to be coupled to the first Wi-Fi module in the smart device and including a soft access point,
wherein:
after detecting the first NFC module is close to the second NFC module, the second NFC module establishes an NFC connection with the first NFC module, and transmits wireless-network-connection-information of the soft access point to the smart device through the NFC connection; and
using the wireless-network-connection-information of the soft access point, the second Wi-Fi module in the electronic apparatus establishes a Wi-Fi connection with the first Wi-Fi module in the smart device.

7. The electronic apparatus according to claim 6, further comprising:
a basic network module for accessing an external network, wherein a network bridge is disposed between the basic network module and the soft access point.

8. The electronic apparatus according to claim 6, further comprising:
a data encryption module corresponding to a data decryption module in the smart device, wherein:
when the second NFC module in the electronic apparatus transmits wireless-network-connection-information of the soft access point to the smart device through the NFC connection, the data encryption module encrypts the wireless-network-connection-information, and the encrypted wireless-network-connection-information is provided to the data decryption module; and
the data decryption module decrypts the encrypted wireless-network-connection-information, and provided the decrypted wireless-network-connection-information to the first NFC module in the smart device.

9. The electronic apparatus according to claim 6, wherein:
the first Wi-Fi module in the smart device includes a first Wi-Fi direct module;
the second Wi-Fi module in the electronic apparatus includes a second Wi-Fi direct module; and
when the first NFC module in the smart device does not obtain the wireless-network-connection-information of the soft access point through the NFC connection, the first Wi-Fi direct module in the smart device establishes a Wi-Fi Direct connection with the second Wi-Fi direct module in the electronic apparatus.

10. The electronic apparatus according to claim 6, wherein:
the smart device includes a first WPS sub-module;
the electronic apparatus includes a second WPS sub-module; and
when the first NFC module in the smart device does not obtain the wireless-network-connection-information of the soft access point through the NFC connection, the first Wi-Fi module in the smart device establishes a wireless network connection with the second Wi-Fi module in the electronic apparatus based on WPS protocols.

11. The electronic apparatus according to claim 10, wherein:
when the first NFC module is close to the second NFC module, the first NFC module in the smart device obtains a pin code or button configuration information through the NFC connection; and
the second WPS sub-module in the electronic apparatus establishes the wireless network connection with the first WPS sub-module in the smart device using the pin code or the button configuration information.

12. A network connection method based on near-field-communication (NFC) for establishing a Wi-Fi connection between a smart device and an electronic apparatus, wherein the smart device includes a first NFC module and a first Wi-Fi module, the electronic apparatus includes a second NFC module and a second Wi-Fi module, and the first Wi-Fi module in the electronic apparatus has a soft access point, the method comprising:
when it is detected that the first NFC module in the smart device is close to the second NFC module in the electronic apparatus, establishing, by the first NFC module, an NFC connection with the second NFC module;
obtaining, by the first NFC module in the smart device, wireless-network-connection-information of the soft access point through the NFC connection; and
using the wireless-network-connection-information of the soft access point, establishing, by the first Wi-Fi module in the smart device, a Wi-Fi connection with the second Wi-Fi module in the electronic apparatus.

13. The method according to claim 12 wherein:
the electronic apparatus includes a basic network module for accessing an external network, a network bridge is disposed between the basic network module and the soft access point, and the soft access point connects to the external network through the network bridge and the basic network module.

14. The method according to claim 12 wherein:
the electronic apparatus includes a data decryption module corresponding to a data encryption module in the smart device, wherein:
when the first NFC module in the smart device obtains the wireless-network-connection-information of the soft access point through the NFC connection, the data encryption module encrypts the wireless-network-connection-information, and the encrypted wireless-network-connection-information is provided to the data decryption module; and
the data decryption module decrypts the encrypted wireless-network-connection-information, and provides the decrypted wireless-network-connection-information to the first NFC module in the smart device.

15. The method according to claim 12, wherein:
the first Wi-Fi module in the smart device includes a first Wi-Fi direct module;
the second Wi-Fi module in the electronic apparatus includes a second Wi-Fi direct module; and
when the first NFC module in the smart device does not obtain the wireless-network-connection-information of the soft access point through the NFC connection, the first Wi-Fi direct module in the smart device establishes a Wi-Fi Direct connection with the second Wi-Fi direct module in the electronic apparatus.

16. The method according to claim 12, wherein:
the smart device includes a first WPS sub-module;
the electronic apparatus includes a second WPS sub-module; and
when the first NFC module in the smart device does not obtain the wireless-network-connection-information of the soft access point through the NFC connection, the first Wi-Fi module in the smart device establishes a wireless network connection with the second Wi-Fi module in the electronic apparatus based on WPS protocols.

17. The method according to claim 16, wherein:
when the first NFC module is close to the second NFC module, the first NFC module in the smart device obtains a pin code or button configuration information through the NFC connection; and
the first WPS sub-module in the smart device establishes the wireless network connection with the second WPS sub-module in the electronic apparatus using the pin code or the button configuration information.
